(19) United States
(12) Patent Application Publication
(10) Pub. No.: US 2025/0327729 A1
(43) Pub. Date: Oct. 23, 2025

(54) QUANTITATIVE EVALUATION METHOD AND SYSTEM FOR STRESS CORROSION SUSCEPTIBILITY OF PIPELINE STEEL WELDING CONNECTOR

(71) Applicant: Tianjin University, Tianjin (CN)

(72) Inventors: Lianyong Xu, Tianjin (CN); Yongdian Han, Tianjin (CN); Liang Li, Tianjin (CN); Yusheng Yan, Tianjin (CN); Kangda Hao, Tianjin (CN); Lei Zhao, Tianjin (CN)

(73) Assignee: Tianjin University, Tianjin (CN)

(21) Appl. No.: 19/064,646

(22) Filed: Feb. 26, 2025

(30) Foreign Application Priority Data
Apr. 22, 2024 (CN) 202410482849.0

(51) Int. Cl. G01N 3/20; G01N 17/00

(52) U.S. Cl. CPC G01N 3/20; G01N 17/00; G01N 2203/0023; G01N 2203/0062; G01N 2203/024; G01N 2203/0296

(57) ABSTRACT

The disclosure belongs to a technical field of a stress corrosion cracking test, and specifically discloses a quantitative evaluation method and system for stress corrosion susceptibility of a pipeline steel welding connector. Through the disclosure, bending tests in a hydrogen sulfide environment is combined with a slow strain rate tensile test to obtain a limit value/range of the stress corrosion susceptibility of the welding connector. Resistance of the welding connector to stress corrosion cracking is unqualified when it is greater than the limit value/exceeds the limit range, otherwise it is qualified.

### CROSS-REFERENCE TO RELATED APPLICATION

This application claims the priority benefit of China application serial no. 202410482849.0, filed on Apr. 22, 2024. The entirety of the above-mentioned patent application is hereby incorporated by reference herein and made a part of this specification.

### BACKGROUND

### Technical Field

The disclosure belongs to a technical field of a stress corrosion cracking test, and more specifically, to a quantitative evaluation method and system for stress corrosion susceptibility of a pipeline steel welding connector.

### Description of Related Art

With the growth of the global economy and the acceleration of industrialization, human demand for primary energy such as oil and natural gas is increasing day by day. Long-distance transportation of oil and gas resources usually relies on oil and gas pipelines. However, currently more and more oil and gas resources contain H₂S gas. The H₂S gas is generally not very corrosive, but it is very easy to dissolve in water to form an acidic solution, causing corrosion of a pipeline. Various types of oil and gas pipelines are susceptible to slight plastic deformation due to crustal changes, wave scouring, and temperature impacts during service. A combined effect of corrosive media and loads may cause stress corrosion cracking (SSC) in the pipeline. When the corrosive medium is sulfide, this phenomenon is called sulfide stress corrosion cracking (SSCC). Occurrence of the stress corrosion cracking may cause cracks in the pipeline and lead to oil and gas leakage, causing serious economic losses and environmental pollution, thereby seriously restricting the application and development of pipeline steel.

A welding connector is a position that is most susceptible to the sulfide stress corrosion cracking in the pipeline steel. Therefore, in order to quantitatively analyze resistance to the sulfide stress corrosion cracking and a failure mode of the pipeline steel, a sulfide stress corrosion cracking test and evaluation are required to be performed on the welding connector.

There are many methods currently used to evaluate H₂S stress corrosion susceptibility of the welding connector, such as a four-point bending test and a slow strain rate tensile test. The four-point bending test is the most commonly used, but it has certain limitations. First, each test takes 720 h, which is time-consuming. Secondly, the four-point bending test may only determine whether the resistance of the welding connector to the stress corrosion cracking is qualified by whether it is broken or not, and may not provide quantitative indexes or improvement guidance for welding processes or materials. The slow strain rate tensile test may obtain quantitative stress corrosion susceptibility indexes, but it is impossible to determine whether the obtained indexes are qualified.

### SUMMARY

In view of defects in the related art, a purpose of the disclosure is to provide a quantitative evaluation method and system for stress corrosion susceptibility of a pipeline steel welding connector, aiming to solve issues that existing stress corrosion testing methods are time-consuming and have no quantitative indexes.

To achieve the above objectives, in the first aspect, the disclosure provides a quantitative evaluation method for stress corrosion susceptibility of a pipeline steel welding connector, including the following.

Average values of stress corrosion susceptibility of all specimens with same welding parameters in a first welding connector specimen group are obtained respectively. Values of the stress corrosion susceptibility are obtained from slow strain rate tensile tests of a welding connector in air and in a corrosive environment.

Bending test results of all the specimens with the same welding parameters in a second welding connector specimen group are obtained respectively. The specimens in the first welding connector specimen group and the specimens in the second welding connector specimen group are connectors of a same base material pipeline steel with a same welding process and different welding parameters.

By comparing the bending test results under each of the welding parameters with the corresponding average values of the stress corrosion susceptibility, a limit value/range of the stress corrosion susceptibility with the same broken/unbroken base material pipeline steel welding connector is obtained.

Preferably, a calculation formula of the values of the stress corrosion susceptibility is:

$${I}_{ψ} = ( 1 - \frac{{ψ}_{C}}{{ψ}_{A}} ) \times 100 \%$$

I_{ψ} represents the stress corrosion susceptibility, and the greater the value, the worse the stress corrosion susceptibility of the specimen. ψ_{C} represents contraction of cross sectional area of a welding connector specimen in the corrosive environment. ψ_{A} represents the contraction of cross sectional area of the welding connector specimen in the air.

Preferably, the bending test is a four-point bending test or a three-point bending test.

Preferably, if all the specimens under a certain welding parameter are not cracked, and micro cracks appear in the specimens under the previous or next welding parameter, the average values of the stress corrosion susceptibility corresponding to the two welding parameters constitute the limit range of the stress corrosion susceptibility.

Preferably, that the method further includes the following. A fracture of the slow strain rate tensile test is observed and analyzed. Brittle fracture morphologies, cracks or surface pits are observed. A basis for improving a welding process is provided.

Preferably, that the method further includes the following.

For the welding connector of the same base material pipeline steel in subsequent new processes, the stress corrosion susceptibility thereof is only obtained through the slow strain rate tensile test, and it is compared with the obtained limit value or limit range to further determine whether the welding process has sufficient resistance to stress corrosion cracking.

Preferably, resistance of the welding connector to the stress corrosion cracking is unqualified when it is greater than the limit value or exceeds the limit range, otherwise it is qualified.

Preferably, the method further includes the following. A magnetic particle test is performed on bending specimens without obvious cracks to ensure that no cracks are generated.

Preferably, the corrosive environment of the slow strain rate tensile test is a solution of 1×10⁻³ mol/L Na₂S₂O₃+NACE TM 0177 A.

To achieve the above objectives, in the second aspect, the disclosure provides a quantitative evaluation system for stress corrosion susceptibility of a pipeline steel welding connector, including:
at least one memory configured to store a program;
at least one processor configured to execute the program stored in the memory, in which when the program stored in the memory is executed, the processor is configured to execute the quantitative evaluation method as described in the first aspect.

It may be understood that beneficial effects of the second aspect may be found in relevant descriptions of the first aspect, which will not be repeated here.

In general, the above technical solutions conceived by the disclosure have the following beneficial effects compared to the related art.

The disclosure provides the quantitative evaluation method and system for the stress corrosion susceptibility of the pipeline steel welding connector, which combines the bending test in a hydrogen sulfide environment with the slow strain rate tensile test to obtain the limit value/range of the stress corrosion susceptibility of the welding connector. The resistance of the welding connector to the stress corrosion cracking is unqualified when it is greater than the limit value/exceeds the limit range, otherwise it is qualified. Before exploring the limit range, the disclosure is required to determine whether different processes are qualified through the bending tests in the corrosive environment. However, after obtaining the limit value/range, it may be determined whether the resistance of the welding connector of the same material to the stress corrosion cracking meets a standard only through the slow strain rate tensile test, which saves the test time to a great extent. In addition, the method may obtain the quantitative indexes, which may provide a direction for the improvement or guidance of the welding process.

### BRIEF DESCRIPTION OF THE DRAWINGS

FIG. 1 is a flow chart of a quantitative evaluation method for stress corrosion susceptibility of a pipeline steel welding connector provided in an embodiment of the disclosure.

FIG. 2 is a schematic view of a sampling position and a size of a four-point bending specimen in a corrosive environment provided in an embodiment of the disclosure.

FIG. 3 is a schematic view of a four-point bending fixture provided in an embodiment of the disclosure.

FIG. 4 is a schematic view of a sealed box for a four-point bending test in a corrosive environment provided in an embodiment of the disclosure.

FIG. 5 is a schematic view of a Cortest slow strain rate tensile test apparatus provided in an embodiment of the disclosure.

FIG. 6 is a schematic view of a sampling position and a size of a slow strain rate tensile specimen provided in an embodiment of the disclosure.

FIG. 7 is a schematic view of a structure of an electronic apparatus provided in the disclosure.

### DETAILED DESCRIPTION OF DISCLOSED EMBODIMENTS

In order for the objectives, technical solutions, and advantages of the disclosure to be more comprehensible, the disclosure is further described in detail below in conjunction with the embodiments accompanied with drawings. It should be understood that the specific embodiments described herein are only used to describe the disclosure and are not used to limit the disclosure.

The term “and/or” herein is a description of an association relationship of associated objects, indicating that there may be three relationships. For example, A and/or B may indicate three situations, which are that A exists alone, A and B exist at the same time, and B exists alone. The symbol “/” herein indicates that the associated objects are in an or relationship. For example, A/B means A or B.

The terms “first”, “second”, etc. in the specification and claims herein are used to distinguish different objects rather than to describe a specific order of the objects. For example, a first response message and a second response message are used to distinguish different response messages rather than to describe a specific order of the response messages.

In the embodiments of the disclosure, words such as “exemplary” or “for example” are used to indicate examples, illustrations, or descriptions. Any embodiment or design described as “exemplary” or “for example” in the embodiments of the disclosure should not be construed as being preferred or advantageous over other embodiments or designs. Specifically, the use of words such as “exemplary” or “for example” are intended to present relevant concepts in a specific manner.

In the description of the embodiments of the disclosure, unless otherwise specified, the meaning of “multiple” refers to two or more than two. For example, multiple processing units refers to two or more processing units, etc., and multiple elements refers to two or more elements, etc.

Next, the technical solutions provided in the embodiments of the disclosure are introduced.

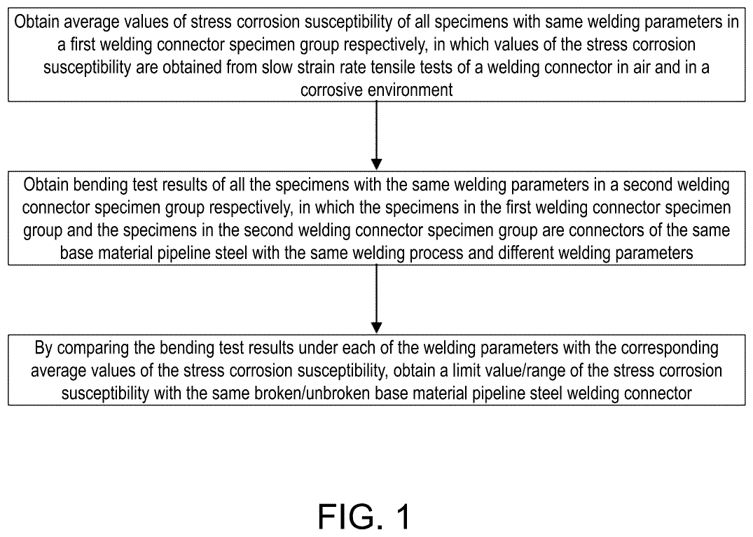

As shown in FIG. 1, the disclosure provides a quantitative evaluation method for stress corrosion susceptibility of a pipeline steel welding connector, including the following.

Average values of stress corrosion susceptibility of all specimens with same welding parameters in a first welding connector specimen group are obtained respectively. Values of the stress corrosion susceptibility are obtained from slow strain rate tensile tests of a welding connector in air and in a corrosive environment.

Bending test results of all the specimens with the same welding parameters in a second welding connector specimen group are obtained respectively. The specimens in the first welding connector specimen group and the specimens in the second welding connector specimen group are connectors of the same base material pipeline steel with the same welding process and different welding parameters.

By comparing the bending test results under each of the welding parameters with the corresponding average values of the stress corrosion susceptibility, a limit value/range of the stress corrosion susceptibility with the same broken/unbroken base material pipeline steel welding connector is obtained.

Preferably, a calculation formula of the value of the stress corrosion susceptibility is:

$${I}_{ψ} = ( 1 - \frac{{ψ}_{C}}{{ψ}_{A}} ) \times 100 \%$$

I^{ψ} represents the stress corrosion susceptibility. The greater the value, the worse the stress corrosion susceptibility of the specimen. ψ_{C} represents contraction of cross sectional area of a welding connector specimen in the corrosive environment. 44 represents the contraction of cross sectional area of the welding connector specimen in the air.

Preferably, the bending test is a four-point bending test or a three-point bending test.

The four-point bending test is mainly performed according to standards of NACE TM 0177-2016 of “Standard Testing Methods for Laboratory Testing of Metals for Resistance to Sulfide”, GB/T 4157-2017 of “Laboratory Testing of Metals for Resistance to Special Forms of Environmental Cracking in Hydrogen Sulfide Environments”, ASTM G39-99 (2021) of “Preparation and Use of Stress Corrosion Test specimens for Bent Beams”, NACE TM0177-2016 of “Stress Corrosion Cracking Test of Metals in Hydrogen Sulfide Environments”, etc.

Preferably, if all the specimens under a certain welding parameter are not cracked, and micro cracks appear in the specimens under the previous or next welding parameter, the average values of the stress corrosion susceptibility corresponding to the two welding parameters constitute a limit range of the stress corrosion susceptibility.

Preferably, the method further includes the following. A fracture of the slow strain rate tensile test is observed and analyzed. Brittle fracture morphologies, cracks, or surface pits are observed. A basis for improving a welding process is provided.

The disclosure quantitatively evaluates the broken, cracked, and unbroken specimens in the conventional hydrogen sulfide stress corrosion test (four-point bending) through the slow strain rate tensile test, and obtains the limit value or limit range of the stress corrosion susceptibility of the welding connector of this material. Combined with macroscopic and microscopic analyses of the fracture and organization observation, it may provide a direction for improvement of the welding process. For the welding connector in subsequent new processes, it is only necessary to obtain the value of the stress corrosion susceptibility thereof through the slow strain rate tensile test and compare the value with the obtained limit value or limit range to determine whether the welding process has sufficient resistance to stress corrosion cracking, which greatly shortens the test time and may quantify a gap between qualified and unqualified processes. Preferably, the method further includes the following.

For the welding connector of the same base material pipeline steel in the subsequent new processes, it is only necessary to obtain the stress corrosion susceptibility thereof through the slow strain rate tensile test and compare it with the obtained limit value or limit range to further determine whether the welding process has sufficient resistance to the stress corrosion cracking.

Preferably, when the value is greater than the limit value or exceeds the limit range, the resistance of the welding connector to the stress corrosion cracking is unqualified, otherwise it is qualified.

Preferably, the method further including the following. A magnetic particle test is performed on bending specimens without obvious cracks to ensure that no cracks are generated.

Preferably, the corrosive environment of the slow strain rate tensile test is a solution of 1×10⁻³ mol/L Na₂S₂O₃+NACE TM 0177 A to ensure normal use of a reactor and safety of the test.

The slow strain rate tensile test is mainly performed according to standards of GB/T 15970.7-2017 of “Corrosion of metals and alloys-Stress corrosion testing-Part 7: Slow strain rate testing”, BS EN ISO 7539-7-2005 of “Corrosion of metals and alloys. Stress corrosion testing-Method for slow strain rate testing”, ISO 7539-7-2005 of “Corrosion of metals and alloys-Stress corrosion testing-Part 7: Method for slow strain rate testing”, ISO 7539-8:2000 of “Corrosion of metals and alloys-Stress corrosion testing-Part 8: Preparation and use of specimens to evaluate weldments”, etc.

### Embodiment

Welding heat input is an important technical index of the welding process, which refers to heat energy of n welding arc or heat of other heat sources obtained per unit length of a weld. The amount of heat input has a direct impact on quality of welding. If the heat input is too large, it will increase unnecessary power consumption and easily cause welding defects such as “undercutting”. If the heat input is too small, the welding defects such as “incomplete penetration” may occur, affecting a strength of the weld.

In this embodiment, five types of heat input CMT welded X65 pipeline steels are prepared. Specimens are taken from a weld root and a middle wall thickness at positions of 3, 6, 9, and 12 o'clock for each type of the heat input pipeline steels, and 3 specimens are taken from each of the positions, for a total of 24 specimens. A yield strength of the X65 pipeline steel is 495 MPa. A loading load is 396 MPa. Loading deflection is 0.86 to 0.90 mm (depending on an actual size of the specimen). The bending test adopts the four-point bending test. Before H₂S is introduced into a solution of NACE A, nitrogen is required to be introduced for 1 hour to remove the air in the sealed box. A saturation concentration of hydrogen sulfide should be greater than 2300 mg/L. The solution in step 1) is required to be tested for the hydrogen sulfide concentration every week to ensure that the concentration is qualified. A test temperature is 24±3° C. The quantitative evaluation method includes the following steps.

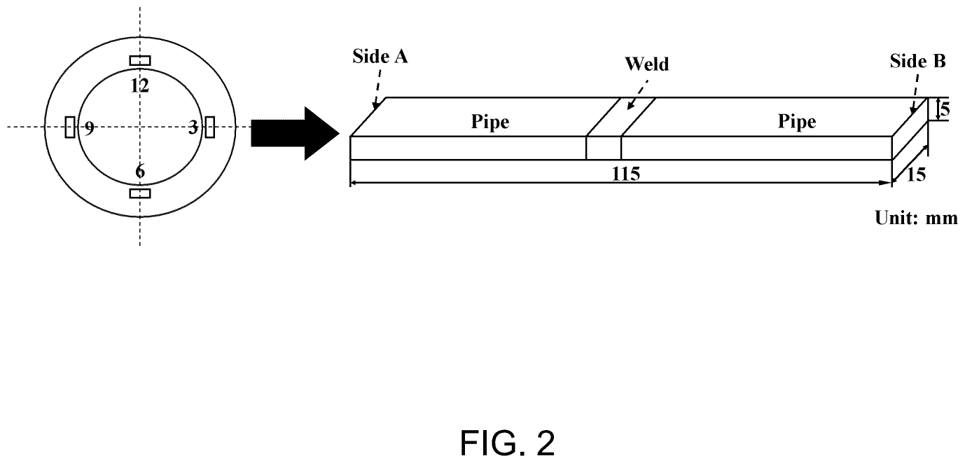

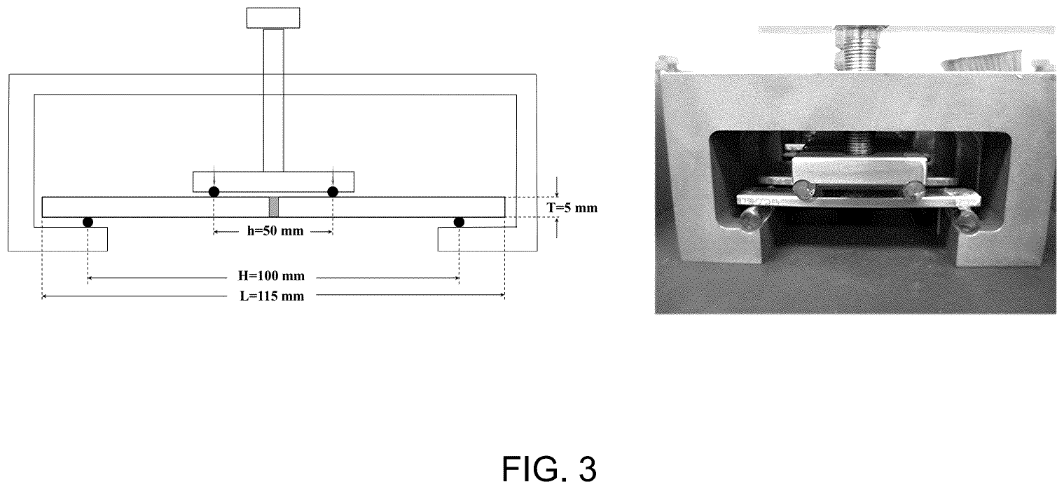

1) The specimens are taken from the weld root and the middle wall thickness of the welding connector at the positions of 3, 6, 9, and 12 o'clock, and a specimen form is shown in FIG. 2. A weld root side is used as a tensile surface to apply deflection loading to the specimen, as shown in FIG. 3. A loading load is 80% of a yield strength of the base material, and a loading formula is as follows.

$$y = \frac{( 3 {H}^{2} - 4 {A}^{2} ) σ}{12 Et}$$

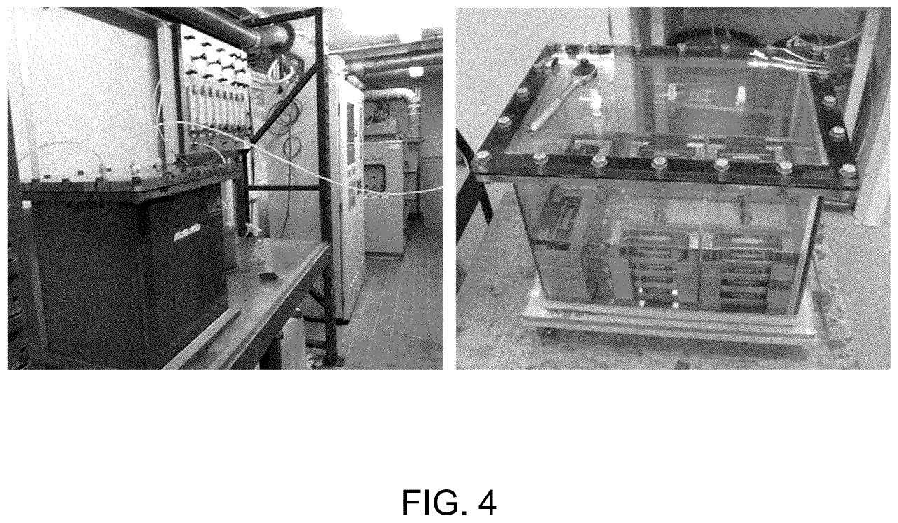

2) An appropriate amount of the solution of NACE TM 0177 A is prepared, and the specimen and the solution are placed in the sealed box, as shown in FIG. 4.

3) After nitrogen is introduced for 1 h to remove all the air in the box, hydrogen sulfide gas is introduced. After a certain period of time, 10 ml of the solution is taken out for titration to determine whether H₂S is saturated.

4) A test duration is 30 days, and the test solution is required to be titrated every week during the test to determine whether H₂S is saturated.

5) After 30 days, the specimens are taken out, and the specimens are observed under a 10× magnifying glass to see whether it is broken or cracked on the tensile surface. If so, it means that the H₂S stress corrosion resistance of the welding connector is unqualified.

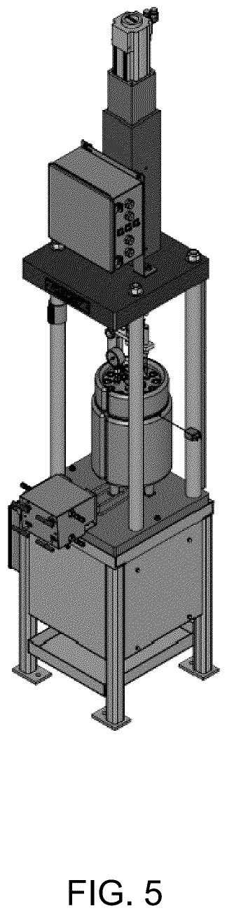

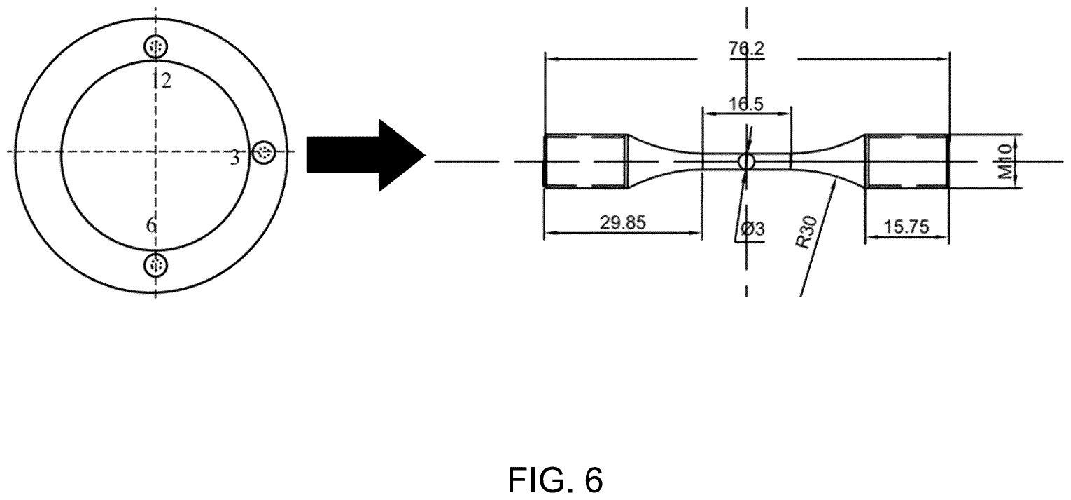

6) The slow strain rate tensile test is performed on different welding connector specimens in the air and the solution of 1×10⁻³ mol/L Na₂S₂O₃+NACE TM 0177 A respectively. A tensile rate is 10⁻⁶ s⁻¹. The test is performed in a reactor of a Cortest testing machine shown in FIG. 5. The size of the specimen is shown in FIG. 6.

7) Cross-sectional areas of the slow strain rate tensile specimen before and after the fracture are measured to obtain the contraction of cross sectional area WA in the air and the cross-contraction of cross sectional area ψ_{C} in the corrosive environment. The value of the stress corrosion susceptibility of the welding connector is obtained by the following formula.

$${I}_{ψ} = ( 1 - \frac{{ψ}_{C}}{{ψ}_{A}} ) \times 100 \%$$

8) The specimen in step 5) are matched one by one with the I_{ψ} obtained in step 7), and finally the limit value or limit range of the stress corrosion susceptibility is obtained. If it is greater than the value or the range, it means that resistance of the welding connector to the stress corrosion cracking is unqualified, otherwise it is qualified.

9) The fracture of the slow strain rate tensile test is observed and analyzed to observe the brittle fracture morphologies, cracks, or surface pits, and provide the basis for improving the welding process.

10) The slow strain rate tensile test is performed on specimens in a new welding process, and the calculated stress corrosion susceptibility I_{ψ} is compared with the limit value to determine whether the new welding connector is qualified in resisting H₂S stress corrosion cracking.

The bending test has the following results. All the specimens of heat input 1 and heat input 2 are broken. The specimen of heat input 3 breaks at the weld root, and the specimen partially breaks at the middle wall thickness. The micro cracks are observed on the surface of the specimen of heat input 4, and the magnetic particle test shows that the resistance of the specimen to the stress corrosion cracking is unqualified. The specimen of heat input 5 does not break, and no cracks are found in the magnetic particle test.

The slow strain rate tensile test is performed on the five specimens of heat input in the air and the corrosive environment, and the average values of the stress corrosion susceptibility are 68.75, 61.12, 53.42, 47.07, and 41.52 respectively. It may be considered that the limit range of the stress corrosion susceptibility of the X65 pipeline steel CMT welding connector is [41.52, 47.07].

If the stress corrosion susceptibility I^{ψ} of the X65 pipeline steel CMT welding connector is less than 41.52, it may be considered that the resistance thereof to the stress corrosion cracking is qualified, and if it is greater than 47.07, it is considered unqualified. If I^{ψ} is in the limit range, the four-point bending test in the corrosive environment is required for determination. If the welding process is required to be improved, performance thereof may be first determined by the slow strain rate tensile test. The welding processes with I_{ψ} outside the range is not required to be subjected to the four-point bending test in the corrosive environment, which provides a quantitative basis for the resistance of the welding connector to the stress corrosion cracking and shortens the test time.

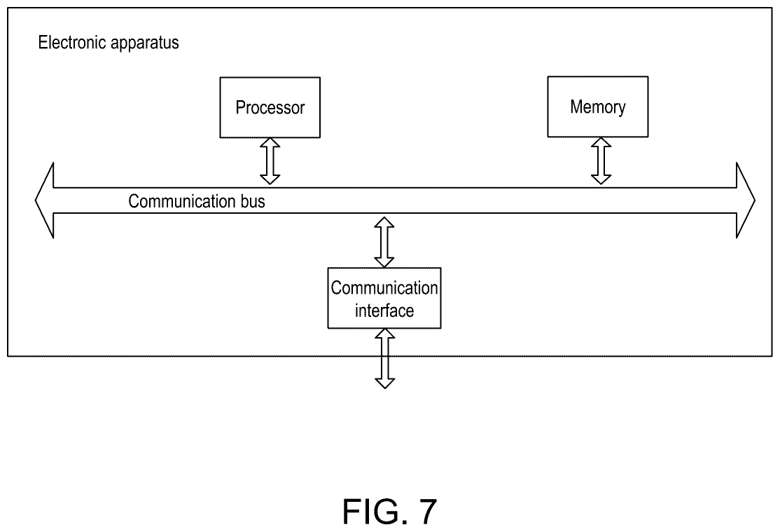

Based on the method in the above embodiment, an embodiment of the disclosure provides an electronic device, as shown in FIG. 7. The electronic device may include a processor, a communication interface, a memory, and a communication bus. The processor, the communication interface, and the memory communicate with each other through the communication bus. The processor may call logic instructions in the memory to execute the method in the above embodiment.

In addition, the logic instructions in the above memory may be implemented in a form of a software functional unit and may be stored in a computer-readable storage medium when sold or used as an independent product. Based on such an understanding, the technical solution in the disclosure, a part that contributes to the related art, or a part of the technical solution may be embodied in a form of a software product. The computer software product is stored in a storage medium and includes several instructions for enabling a computer device (which may be a personal computer, a server, a network device, etc.) to execute all or a part of the steps of the method described in each of the embodiments of the disclosure.

Based on the method in the above embodiment, an embodiment of the disclosure provides a computer-readable storage medium, and the computer-readable storage medium stores a computer program. When the computer program runs on the processor, the processor executes the method in the above embodiment.

Based on the method in the above embodiment, an embodiment of the disclosure provides a computer program product. When the computer program product runs on the processor, the processor executes the method in the above embodiment.

It may be understood that the processor in the embodiment of the disclosure may be a central processing unit (CPU), or may further be other general-purpose processors, digital signal processors (DSP), application specific integrated circuits (ASIC), field programmable gate arrays (FPGA), or other programmable logic devices, transistor logic devices, hardware components or any combination thereof. The general-purpose processor may be a microprocessor or any conventional processor.

The steps of the method in the embodiment of the disclosure may be implemented by hardware, or by the processor executing software instructions. The software instructions may be composed of corresponding software modules. The software modules may be stored in a random access memory (RAM), flash memory, read-only memory (ROM), programmable ROM (PROM), erasable PROM (EPROM), electrically EPROM (EEPROM), register, hard disk, mobile hard disk, CD-ROM, or any other form of storage medium known in the art. An exemplary storage medium is coupled to the processor, so that the processor may read information from, and write information to, the storage medium. Of course, the storage medium may also be an integral part of the processor. The processor and the storage medium may reside in the ASIC.

In the above embodiments, all or a part of the embodiments may be implemented by software, hardware, firmware, or any combination thereof. When implemented using the software, all or a part of the embodiments may be implemented in a form of the computer program product. The computer program product includes one or more computer instructions. When the computer program instructions are loaded and executed on a computer, all or a part of processes or functions described in the embodiment of the disclosure are generated. The computer may be a general-purpose computer, a special-purpose computer, a computer network, or other programmable device. The computer instructions may be stored in the computer-readable storage medium or transmitted through the computer-readable storage medium. The computer instructions may be transmitted from one website, computer, server, or data center to another website, computer, server, or data center in wired (e.g., a coaxial cable, an optical fiber, a digital subscriber line (DSL)) or wireless (e.g., infrared, wireless, microwave, etc.) manner. The computer-readable storage medium may be any available medium that may be accessed by the computer or a data storage device such as the server or the data center that includes one or more available media. The available medium may be a magnetic medium (e.g., a floppy disk, a hard disk, a magnetic tape), an optical medium (e.g., a DVD), or a semiconductor medium (e.g., a solid state disk (SSD)).

It should be understood that various reference numerals involved in the embodiments of the disclosure are only used for the convenience of description and are not used to limit the scope of the embodiments of the disclosure.

It will be easily understood by those skilled in the art that the above description is only a preferred embodiment of the disclosure and is not intended to limit the disclosure. Any modifications, equivalent substitutions, and improvements made within the spirit and principles of the disclosure shall be included in the scope of the disclosure.

1. A quantitative evaluation method for stress corrosion susceptibility of a pipeline steel welding connector, the quantitative evaluation method comprising:
obtaining average values of stress corrosion susceptibility of all specimens with same welding parameters in a first welding connector specimen group respectively, wherein values of the stress corrosion susceptibility are obtained from slow strain rate tensile tests of a welding connector in air and in a corrosive environment;
obtaining bending test results of all the specimens with the same welding parameters in a second welding connector specimen group respectively, wherein the specimens in the first welding connector specimen group and the specimens in the second welding connector specimen group are connectors of a same base material pipeline steel with a same welding process and different welding parameters;
comparing the bending test results under each of the welding parameters with the corresponding average values of the stress corrosion susceptibility, wherein if all the specimens under a certain welding parameter are not cracked, and micro cracks appear in the specimens under the previous or next welding parameter, the average values of the stress corrosion susceptibility corresponding to the certain welding parameter and the previous or next welding parameters constitute a limit range of the stress corrosion susceptibility, and
using the limit range to quantitatively evaluate the stress corrosion susceptibility of the welding connector,
wherein after obtaining the limit range, the sufficient resistance to stress corrosion cracking of the corresponding welding connector is judged to be qualified by judging that the test results of the slow strain rate tensile tests are within the limit range, otherwise it is unqualified.

2. The quantitative evaluation method according to claim 1, wherein a calculation formula of the values of the stress corrosion susceptibility is:
$${I}_{ψ} = ( 1 - \frac{{ψ}_{C}}{{ψ}_{A}} ) \times 100 \%$$
wherein I_{ψ} represents the stress corrosion susceptibility, the greater the value, the worse the stress corrosion susceptibility of the specimen, ψ_{C} represents contraction of cross sectional area of a welding connector specimen in the corrosive environment, and ψ_{A} represents the contraction of cross sectional area of the welding connector specimen in the air.

3. The quantitative evaluation method according to claim 1, wherein the bending test is a four-point bending test or a three-point bending test.

4. The quantitative evaluation method according to claim 1, wherein the method further comprises: observing and analyzing a fracture of the slow strain rate tensile test, observing brittle fracture morphologies, cracks or surface pits, and providing a basis for improving a welding process.

5. (canceled)

6. (canceled)

7. The quantitative evaluation method according to claim 1, wherein the method further comprises: performing a magnetic particle test on bending specimens without obvious cracks to ensure that no cracks are generated.

8. The quantitative evaluation method according to claim 1, wherein the corrosive environment of the slow strain rate tensile test is a solution of 1×10⁻³ mol/L Na₂S₂O₃+NACE TM 0177 A.

9. A quantitative evaluation system for stress corrosion susceptibility of a pipeline steel welding connector, characterized by comprising:
at least one memory configured to store a program;
at least one processor configured to execute the program stored in the memory, wherein when the program stored in the memory is executed, the processor is configured to execute the quantitative evaluation method according to claim 1.
